(19) United States
(12) Patent Application Publication
(10) Pub. No.: US 2014/0153870 A1
(43) Pub. Date: Jun. 5, 2014

(54) MONOLITHIC SPLITTER ASSEMBLY

(71) Applicant: MiMetrix Design Group, L.L.C., Reston, VA (US)

(72) Inventor: Elliott Starin, Rocky Ridge, MD (US)

(73) Assignee: MiMetrix Design Group, L.L.C., Reston, VA (US)

(21) Appl. No.: 14/069,005

(22) Filed: Oct. 31, 2013

Related U.S. Application Data
(60) Provisional application No. 61/733,455, filed on Dec. 5, 2012.

(51) Int. Cl. G02B 6/28

(52) U.S. Cl. CPC G02B 6/28
USPC 385/24

(57) ABSTRACT

Technologies are presented that provide a monolithic splitter assembly that may, for example, be used in a network computing system for network signal monitoring. A method of routing an optical signal in such a system can include receiving one or more optical input signals at one or more respective inputs, the one or more optical input signals originating at a first device; and for each of the one or more optical input signals, splitting the optical input signal into two or more split input signals along a respective pathway etched onto a medium; outputting a first split input signal of the two or more split input signals at a first output, the first split input signal intended for a second device; and outputting a second split input signal of the two or more split input signals at a second output, the second split input signal intended for a third device.

### CROSS-REFERENCE TO RELATED APPLICATIONS

This application claims the benefit of U.S. Provisional Patent Application No. 61/733,455, filed Dec. 5, 2012, the disclosure of which is hereby incorporated by reference in its entirety.

### TECHNICAL FIELD

The technologies described herein generally relate to the splitting of optical signals. More specifically, the technologies described herein relate to the splitting of optical signals for network signal monitoring.

### BACKGROUND

Optical splitters can be used to split an optical signal into two or more optical signals to be provided to two or more destinations. Optical splitter assemblies currently exist that use a plurality of couplers to achieve the splitting of multiple fibers. However, depending on factors such as number of splitters needed, number of outputs needed, etc., conventional optical splitter assemblies may need to be significantly large to hold the necessary amount of optical cables and splitters. Furthermore, when used for network signal monitoring, conventional optical splitters often do not easily scale to meet technical requirements for high-density port counts. Thus, there is a need for a splitter assembly that can contain a multitude of splitters at high density and full functionality yet with considerably smaller packaging.

### BRIEF DESCRIPTION OF THE DRAWINGS/FIGURES

FIG. 1 is a block diagram of an example optical signal routing system using a monolithic splitter assembly, according to an embodiment.

FIG. 2 illustrates an example of the pinouts used in the monolithic splitter assembly of FIG. 1, according to an embodiment.

FIG. 3 illustrates some examples of optical fiber ribbon core configurations, according to embodiments.

FIG. 4 is a block diagram of an example optical signal routing system using a monolithic splitter assembly with bi-directional signal flow, according to an embodiment.

FIG. 5 illustrates an example of the signal routing of the monolithic splitter assembly of FIG. 4, according to an embodiment.

FIG. 6 illustrates an example of an alternate splitter array layout, according to an embodiment.

FIG. 7 is a flow chart illustrating an example method of routing an optical signal using, for example, the system shown in FIG. 1, according to an embodiment.

FIG. 8 is a flow chart illustrating an example method of routing an optical signal using, for example, the system shown in FIG. 4, according to an embodiment.

FIG. 9 is a block diagram of an example device that may represent any of the transmitting or receiving devices shown in FIGS. 1 and 4, according to embodiments.

In the drawings, the leftmost digit(s) of a reference number may identify the drawing in which the reference number first appears.

### DETAILED DESCRIPTION

Disclosed herein are technologies that solve the technical problem of providing a high density optical signal splitting solution for use in, for example, network signal monitoring. With the technologies disclosed herein, integrated monolithic optical splitter assemblies that use planar lightwave circuit (PLC) technology are presented. These integrated assemblies provide cost-effective, compact, high-density solutions for efficient monitoring of optical signals by network analytic devices.

Embodiments are now described with reference to the figures, where like reference numbers may indicate identical or functionally similar elements. While specific configurations and arrangements are discussed, it should be understood that this is done for illustrative purposes only. A person of ordinary skill in the relevant art will recognize that other configurations and arrangements can be used without departing from the spirit and scope of the description. It will be apparent to a person of ordinary skill in the relevant art that this can also be employed in a variety of other systems and applications other than what is described herein.

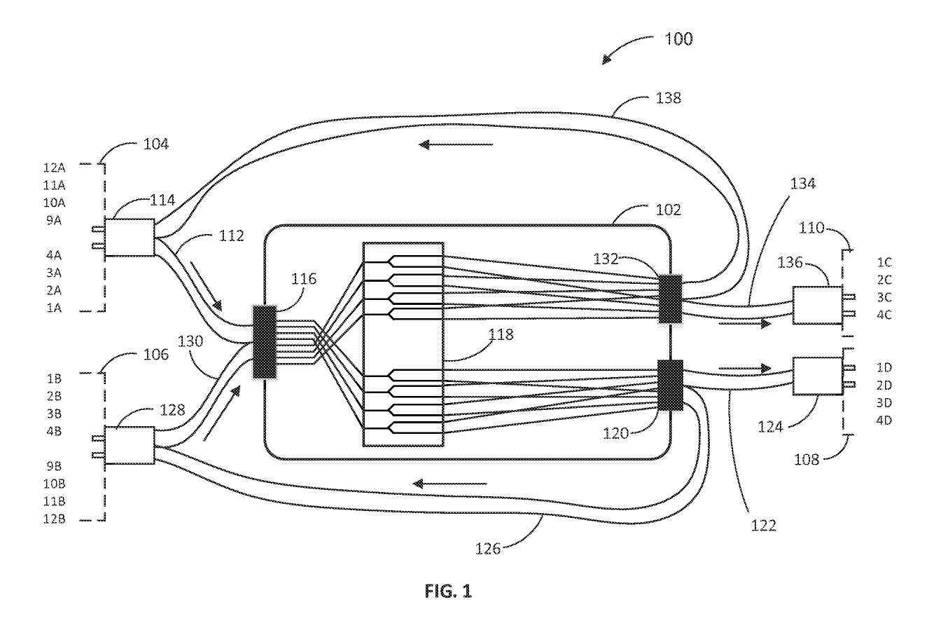

FIG. 1 is a block diagram of an example optical signal routing system 100 using a monolithic splitter assembly 102, according to an embodiment. In system 100, splitter assembly 102 is configured to receive signals from a first network device 104 and a second network device 106, and route the appropriate signals to devices 104, 106, a third device 108, and a fourth device 110 as follows, per the directional arrows shown.

Via a fiber optic cable 112 and connector 114, one or more first optical signals (in this example, four signals, at connector pinouts 1A, 2A, 3A, and 4A) can be routed from device 104 as input to splitter assembly 102 at input port 116. The first optical signals can each be split by splitter array 118 and routed to output port 120. A first split signal of each first optical signal can be routed to device 108, via fiber optic cable 122 and connector 124 (in this example, at connector pinouts 4D, 3D, 2D and 1D, respectively). A second split signal of each first optical signal can be routed to device 106, via fiber optic cable 126 and connector 128 (in this example, at connector pinouts 9B, 10B, 11B and 12B, respectively).

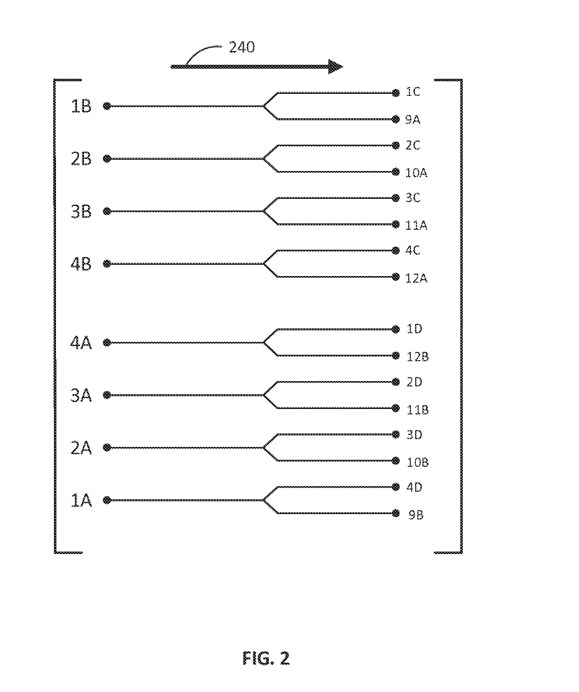

Via a fiber optic cable 130 and connector 128, one or more second optical signals (in this example, four signals, at connector pinouts 1B, 2B, 3B, and 4B) can be routed from device 106 as input to splitter assembly 102 at input port 116. The second optical signals can each be split by splitter array 118 and routed to output port 132. A first split signal of each second optical signal can be routed to device 110, via fiber optic cable 134 and connector 136 (in this example, at connector pinouts 1C, 2C, 3C and 4C, respectively). A second split signal of each second optical signal is routed to device 104, via fiber optic cable 138 and connector 114 (in this example, at connector pinouts 9A, 10A, 11A and 12A, respectively). The pinouts from the example shown in FIG. 1 are shown more clearly in FIG. 2, where the direction of the signals are shown by the directional arrow 240. The signal routing and pinout example shown in FIG. 1 is one example. It would be understood by one of ordinary skill in the art that there are many different signal routing and pinout arrangements that can be used without departing from the scope of this disclosure.

Devices 104 and 106 can each be any networked computing device, such as but not limited to, for example, a desktop computer, a laptop, a portable computing device, a workstation, a client, a server, a network device, etc. Examples of network devices can include but are not to be limited to, for example, Ethernet switches, routers, etc. Devices 108 and 110 can also be any networked computing device. In an embodiment where system 100 is used for network signal monitoring, devices 108 and 110 can be network analytic devices. Examples of network analytic devices can include computing or server devices that are configured (e.g., with software, hardware, and/or firmware) to perform one or more network analytic functions. A network analytic device can also be a specialized customized device. Examples of network analytic functions can include, but are not to be limited to, for example, recording, archiving, security information and event management (SIEM), data loss prevention (DLP), service level agreement (SLA) functions, quality of experience, quality of service, quality of application, application delivery control (ADC), Deep Packet Inspection (DPI), etc. Although four devices are shown in example system 100, any number of devices (network devices and/or network analytic devices) can be included. As an example, in the shown embodiment, two network analytic devices can be used (i.e., devices 108 and 110). However, network signal monitoring can be done for all of the input optical signals using a single network analytic device, or more than two network analytic devices.

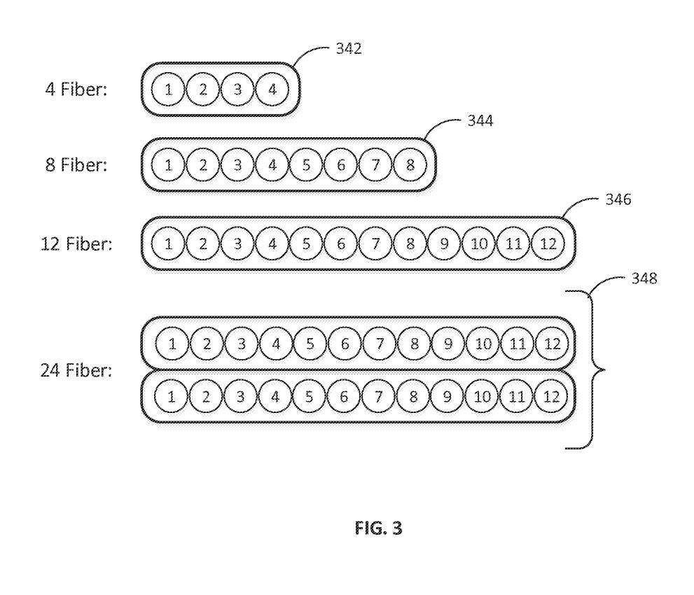

Fiber optic cables 112, 122, 126, 130, 134, and 138 may be ribbonized fiber optic cabling, or fiber ribbon, and can contain as many fiber cores as necessary for the application. Any suitable fiber (e.g., OS1, OS2, OM3, OM4, etc.) and fiber ribbon can be used, as would be understood by one of ordinary skill in the art. The fibers used can be single-mode fibers, multi-mode fibers, or both. Any suitable fiber connector or future-developed connector can be used to terminate a fiber ribbon and connect each fiber to the desired devices. For example, Multiple-Fiber Push-On (MPO-style) connectors can be used. In the example shown in FIG. 1, connectors 114 and 128 can each accommodate twelve fiber cores, though only cores 1-4 and 9-12 are used, while cores 5-8 are unused. Connectors 124 and 136 can each accommodate at least four cores, as only four are used in this example. Some examples of fiber ribbon cross-sections are shown in FIG. 3. Cross-section 342 illustrates a 4-core fiber ribbon. Cross-section 344 illustrates an 8-core fiber ribbon. Cross-section 346 illustrates a 12-core fiber ribbon. Cross-section 348 illustrates a 24-core fiber ribbon. Although connectors are shown in embodiments provided herein, connectors need not be used, as would be understood by those of ordinary skill in the art.

Splitter assembly 102 may include a housing, inside which a plurality of optical fibers can each be connected to respective optical splitters. The optical splitters can be etched onto a medium, using, for example, planar lightwave circuit (PLC) technology, resulting in a monolithic splitter assembly. The medium can include, but is not to be limited to, for example, a polymer medium, a silica medium, or a silica on silicon medium. For example, if using single-mode fiber, one may choose to use silica or silica on silicon. If using multi-mode fiber, one may choose to use polymer or silica on silicon. The optical splitters can be etched as a grouped assembly (referred to in this example as splitter array 118). The layout of splitter assembly 102 is to show the signal routing for ease of description and understanding. The actual placement of the fibers may vary and is not pertinent to the disclosure, except that some configurations of fiber placement may allow for a smaller assembly. It is important to note that splitter assembly 102, as pictured, is not to scale, and is drawn this way for ease of description and understanding. The minimum size of splitter assembly 102 may differ depending on the number of splitters, though can be on the order of 25×10×5 millimeters or even smaller. In this way, the monolithic nature of splitter assembly 102, along with an optimal layout of splitters can provide a much tidier and space-saving device as compared to conventional splitter assemblies.

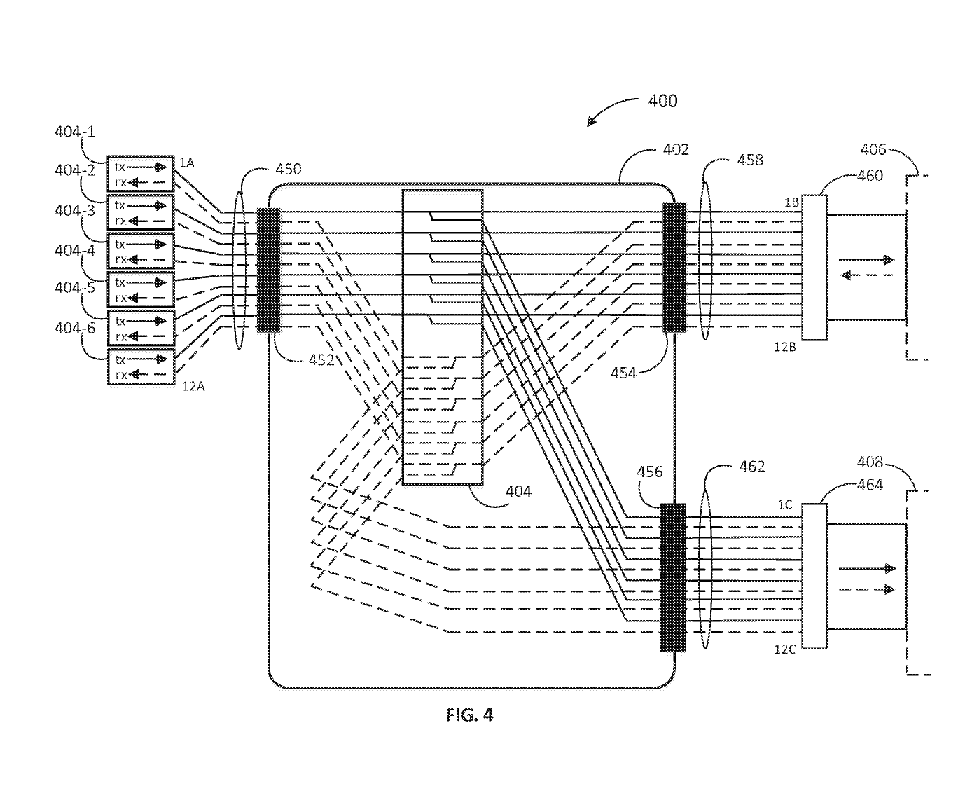

Splitter assembly 102 is shown with one input port 116 and two output ports 120 and 132, as a possible example. As would be understood by those of ordinary skill in the art, any number of input ports and output ports can be included. For example, in alternate embodiments, splitter assembly 102 can have more than one input port (e.g., one for each of cables 112 and 130, one for each signal, etc.), and any number of output ports (e.g., one large output port for cables 122, 126, 134, and 138 to share; four output ports (e.g., one for each of cables 122, 126, 134, and 138); or other combinations of cables and output ports). In embodiments, a port can be used as both an input port and an output port, as shown and described below with reference to FIG. 4. In embodiments, at the input and output ports, the fiber ribbon of cables 112, 122, 126, 130, 134, and 138 can be terminated at a linking fiber array and epoxied or otherwise affixed. In other embodiments, connectors can be used, as would be understood by those of ordinary skill in the art.

The splitters of splitter array 118 can be configured to split each signal into two signals. In other embodiments, splitters of splitter array 118 can be configured to split each signal into more than two signals. Each splitter can be configured to have the same splitter ratio or splitter ratios may differ among the splitters. In one example, all splitters may have a splitter ratio of 50/50 or 60/40 or another splitter ratio. In another example, one or more splitters may have a splitter ratio of 50/50, while other splitters may have a splitter ratio that is other than 50/50. In yet another example, all splitters may have a splitter ratio that is other than 50/50, though the splitter ratios need not be identical.

FIG. 4 is a block diagram of an example optical signal routing system 400 using a monolithic splitter assembly with bi-directional signal flow, according to an embodiment. In system 400, splitter assembly 402 is configured to receive signals from one or more first network devices 404 (in this example, there are six first network devices) and one or more second network devices 406 (in this example there is one second network device), and route the appropriate signals to devices 404, 406, and a third device 408 as follows, per the directional arrows shown.

Via a fiber optic cable 450, one or more first optical signals (in this example, six signals, shown as 1A, 3A, 5A, 7A, 9A, and 11A by solid lines) can be routed from devices 404 as input to splitter assembly 402 at port 452. The first optical signals can each be split by splitter array 404 and each split signal can be routed to ports 454 and 456. A first split signal of each first optical signal can be routed to device 406, via port 454, fiber optic cable 458, and connector 460 (in this example, shown as 1B, 3B, 5B, 7B, 9B, and 11B by solid lines). A second split signal of each first optical signal can be routed to device 408, via port 456, fiber optic cable 462, and connector 464 (in this example, shown as 1C, 3C, 5C, 7C, 9C, and 11C by solid lines).

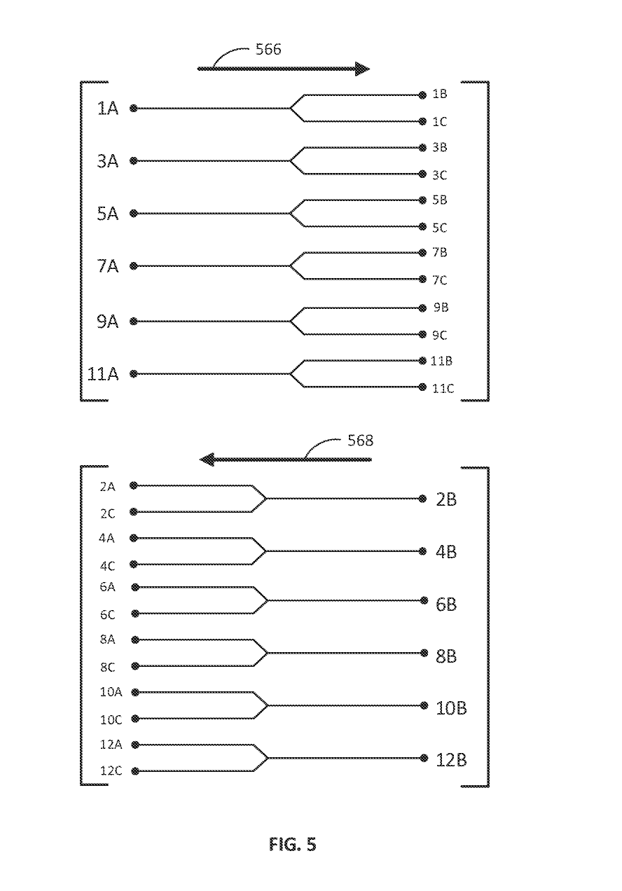

Via fiber optic cable 458, one or more second optical signals (in this example, six signals, shown as 2B, 4B, 6B, 8B, 10B, and 12B as dashed lines) can be routed from device 406 as input to splitter assembly 402 at port 454. The second optical signals can each be split by splitter array 404 and routed to ports 452 and 456. A first split signal of each second optical signal can be routed to devices 404, via port 452 and fiber optic cable 450 (in this example, shown as 2A, 4A, 6A, 8A, 10A, and 12A by dashed lines). A second split signal of each second optical signal can be routed to device 408, via port 456, fiber optic cable 462, and connector 464 (in this example, as 2C, 4C, 6C, 8C, 10C, and 12C by dashed lines). The routing endpoints of the example shown in FIG. 4 are shown more clearly in FIG. 5, where the direction of the signals are shown by the directional arrows 566 and 568. The signal routing example shown in FIG. 4 is one example. It would be understood by one of ordinary skill in the art that there are many different signal routing arrangements that may be used without departing from the scope of this disclosure.

Devices 404 and 406 can each be any networked computing device, as described above with reference to the network devices of FIG. 1. Device 408 can also be any networked computing device. In an embodiment where system 400 is used for network signal monitoring, device 408 can be a network analytic device, as described above with reference to the network analytic devices of FIG. 1. In the example of FIG. 4, devices 404 include six devices, each with a single output signal and a single input signal. Although six devices are shown to represent devices 404, any number of devices may be included. Similarly, although only one device 406 and one device 408 are shown, any number of devices 406 or 408 may be included. For example, fiber optic cables 458 and/or 462 may fan out, similar to cable 450, to direct the respective signals to multiple devices as opposed to a single device.

Similar to the fiber optic cables of FIG. 1, fiber optic cables 450, 458, and 462 can be ribbonized fiber optic cabling, or fiber ribbon, and can contain as many fiber cores as necessary for the application. Any suitable fiber (e.g., OS/1, OS/2, etc.) and fiber ribbon can be used, as would be understood by one of ordinary skill in the art. The fibers used can be single-mode fibers, multi-mode fibers, or both. In the example shown in FIG. 4, the fiber optic cables 450, 458, and 462 are bidirectional cables, where signals can be run in opposite directions, for example, as shown by the solid lines and dashed lines.

Similar to the fiber connectors described earlier with respect to FIG. 1, any suitable fiber connector or future-developed connector can be used to terminate a fiber ribbon or cable and connect each fiber to the appropriate devices. In the example shown in FIG. 4, connectors for devices 404 are not shown for ease of illustration, but could be included, as would be understood by those of ordinary skill in the art. In FIG. 4, connectors 460 and 464 can each accommodate at least twelve fiber cores, as twelve are used in this example. Although connectors are shown in embodiments provided herein, connectors need not be used, as would be understood by those of ordinary skill in the art.

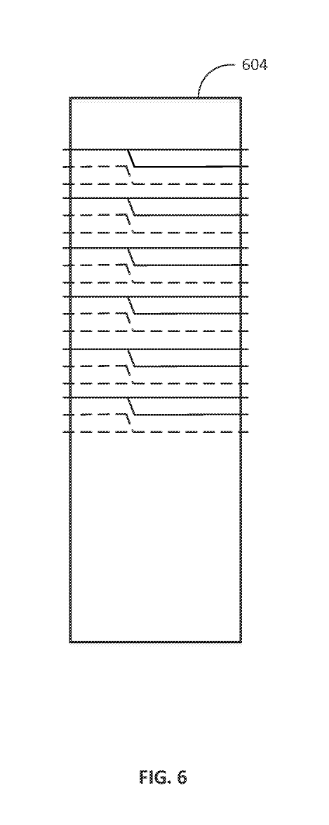

Splitter assembly 402 may be similar to splitter assembly 102 of FIG. 1, except it may have differing port, splitter array, and/or fiber layouts. For example, ports 452 and 454 of splitter assembly 402 can act as both input and output ports, while port 456 is configured as an output port only. The splitter array layout of splitter array 404 and the overall fiber layout can be designed in many various ways, as would be understood by those of ordinary skill in the art. For example, FIG. 6 illustrates an example of an alternate splitter array layout, according to an embodiment. In order to conserve space and/or fit a smaller footprint, splitter arrays can have an arrangement of splitters similar to what is shown in FIG. 6, with every other splitter alternating in placement by approximately 180 degrees.

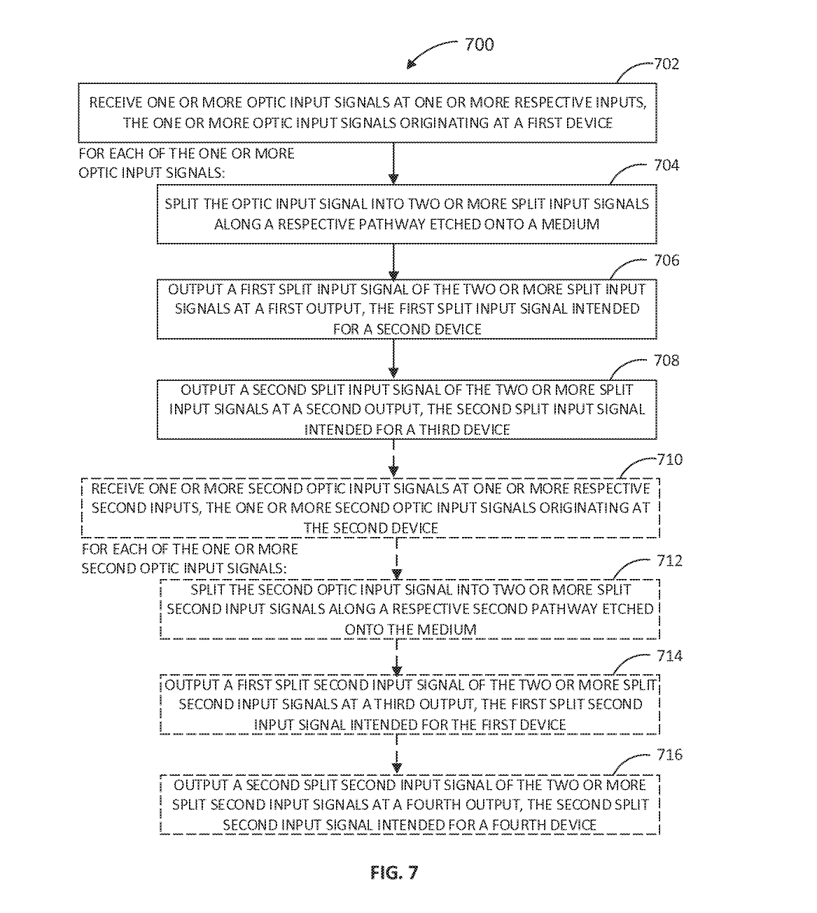

FIG. 7 is a flow chart illustrating an example method 700 of routing an optical signal using, for example, the system shown in FIG. 1, according to an embodiment. At 702, one or more optical input signals can be received at one or more respective inputs, the one or more optical input signals originating at a first device (e.g., a first network device). For each of the one or more optical input signals: at 704, the optical input signal can be split into two or more split input signals along a respective pathway etched onto a medium; at 706, a first split input signal of the two or more split input signals can be output at a first output with the first split input signal intended for a second device (e.g., a second network device); and at 708, a second split input signal of the two or more split input signals can be output at a second output with the second split input signal intended for a third device (e.g., a network analytic device).

Optionally in method 700, input signals may come from the second device, as was shown and described earlier with reference to FIG. 1. In this embodiment, at 710, one or more second optical input signals can be received at one or more respective second inputs, the one or more second optical input signals originating at the second device (e.g., the second network device). For each of the one or more second optical input signals: at 712, the second optical input signal can be split into two or more split second input signals along a respective second pathway etched onto the medium; at 714, a first split second input signal of the two or more split second input signals can be output at a third output with the first split second input signal intended for the first device (e.g., the first network device); and at 716, a second split second input signal of the two or more split second input signals can be output at a fourth output with the second split second input signal intended for a fourth device (e.g., a second network analytic device).

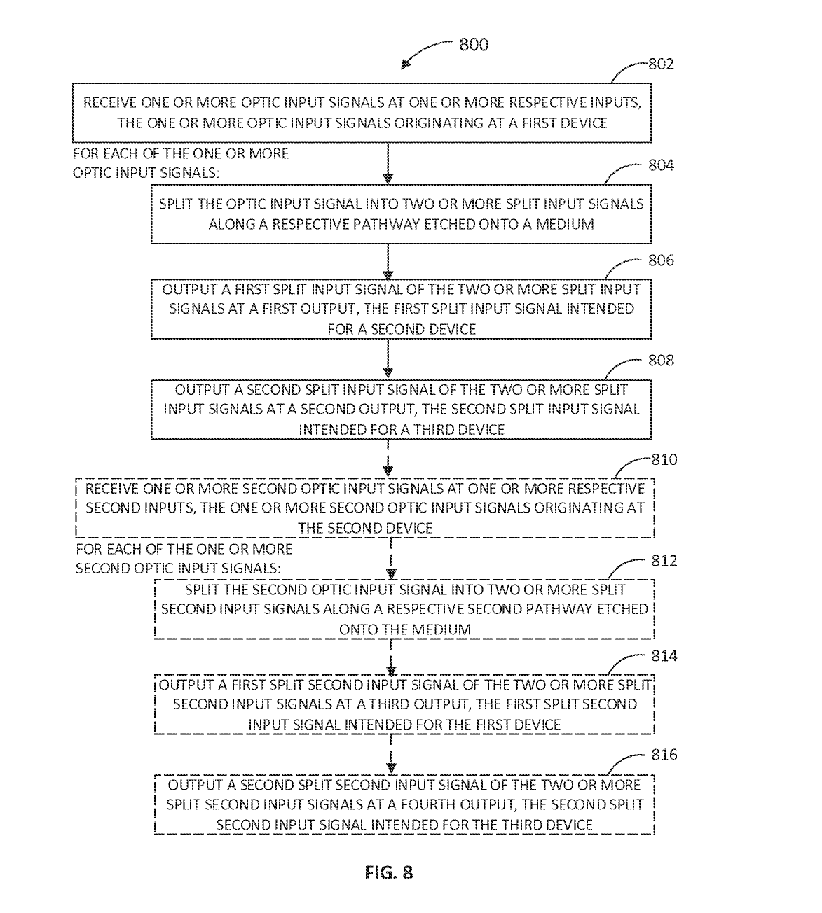

FIG. 8 is a flow chart illustrating an example method 800 of routing an optical signal using, for example, the system shown in FIG. 4, according to an embodiment. Blocks 802-808 of method 800 are similar to blocks 702-708 of method 700. At 802, one or more optical input signals can be received at one or more respective inputs, the one or more optical input signals originating at a first device (e.g., a first network device). For each of the one or more optical input signals: at 804, the optical input signal can be split into two or more split input signals along a respective pathway etched onto a medium; at 806, a first split input signal of the two or more split input signals can be output at a first output with the first split input signal intended for a second device (e.g., a second network device); and at 808, a second split input signal of the two or more split input signals can be output at a second output with the second split input signal intended for a third device (e.g., a network analytic device).

Optionally, in method 800, input signals may come from the second device, intended for the third device, as was shown and described earlier with reference to FIG. 4. At 810, one or more second optical input signals can be received at one or more respective second inputs, the one or more second optical input signals originating at the second device. For each of the one or more second optical input signals: at 812, the second optical input signal can be split into two or more split second input signals along a respective second pathway etched onto the medium; at 814, a first split second input signal of the two or more split second input signals can be output at a third output with the first split second input signal intended for the first device (e.g., the first network device); and at 816, a second split second input signal of the two or more split second input signals can be output at a fourth output with the second split second input signal intended for the third device (e.g., the network analytic device).

There are many additional features that can be incorporated with the technologies described herein, as would be understood by those of ordinary skill in the art. For example, various features of Photonic Integrated Circuits (PIC) can be incorporated.

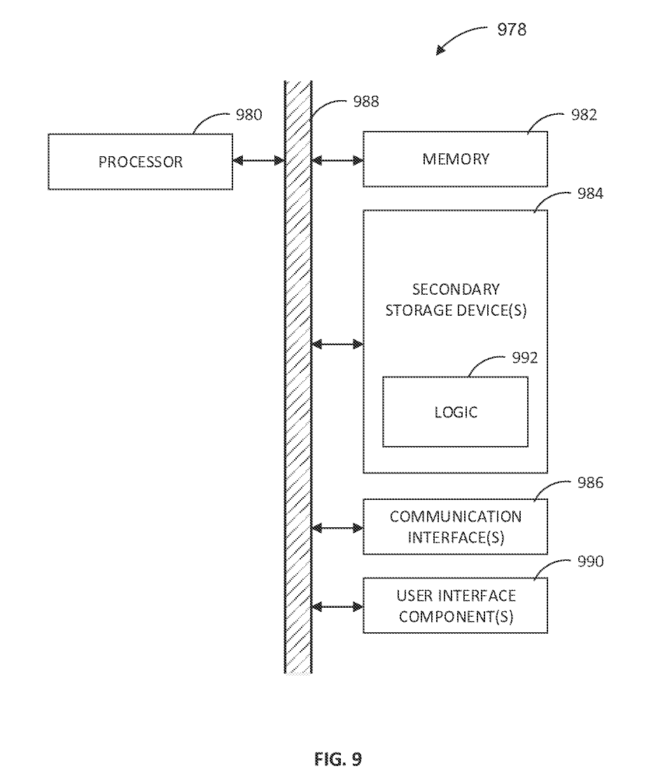

FIG. 9 is a block diagram of an example device 978 that may represent any of the transmitting or receiving devices shown in FIGS. 1 and 4, according to embodiments. Device 978 may represent, for example, any of devices 104, 106, 108, or 110 of FIG. 1, or devices 404, 406, or 408 of FIG. 4. Device 978 can be, for example, a server, a client, a workstation, an Ethernet switch, a router, a storage area network (SAN) device, a network analytic (or monitoring) device, or another type of computing device that may be networked. Device 978 can include a processor or controller 980 connected to memory 982, one or more secondary storage devices 984, and a communication interface 986 by a link 988 or similar mechanism. Device 978 can also include user interface components 990 for use by a user of the device (e.g., a user of a workstation, a system or network administrator, etc.), that may include, for example, a touchscreen, a display, one or more user input components (e.g., a keyboard, a mouse, etc.), a speaker, or the like, or any combination thereof. Note, however, that while not shown, device 978 can include additional components. The processor 980 can be a microprocessor, digital ASIC, FPGA, or similar hardware device. In an embodiment, the processor 980 can be a microprocessor, and software may be stored or loaded into the memory 982 for execution by the processor 980 to provide the functions of device 978. The one or more secondary storage devices 984 can be, for example, one or more hard drives or the like, and can store logic 992 to be executed by the processor 980. The one or more secondary storage devices 984 can also store data for use in providing the functions of device 978. The communication interface 986 can be implemented in hardware or a combination of hardware and software. The communication interface 986 can provide a wired and/or wireless network interface to a network to which device 978 belongs.

One or more features or functions of device 978 may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The terms software and firmware, as used herein, refer to a computer program product including at least one computer readable medium having computer program logic, such as computer-executable instructions, stored therein to cause a computer system to perform one or more features and/or combinations of features disclosed herein. The computer readable medium may be transitory or non-transitory. An example of a transitory computer readable medium may be a digital signal transmitted over a radio frequency or over an electrical conductor, through a local or wide area network, or through a network such as the Internet. An example of a non-transitory computer readable medium may be a compact disk, a flash memory, SRAM, DRAM, a hard drive, a solid state drive, or other data storage device, for example.

Technologies disclosed herein provide high density optical signal splitting solutions with smaller packaging than conventional splitting solutions for use in, for example, network signal monitoring. These integrated PLC assemblies may provide cost-effective, compact solutions for efficient monitoring of very few to very many optical signals by network analytic devices. In addition to the minimization of physical dimensionality, which provides the ability to be incorporated into existing (or even smaller) cassettes, there are many other advantages to the technologies described herein. For example, insertion loss is minimized while link budget is maximized. In addition, the technologies described are suitable for single or multi-mode usage, as well as bidirectional or unidirectional usage. Another advantage is that ribbonized fiber or non-ribbonized fiber may be used, with or without connectors.

It is to be appreciated that the Detailed Description section, and not the Abstract section, is intended to be used to interpret the claims. The Abstract section may set forth one or more but not all example embodiments of the disclosed technologies as contemplated by the inventor, and thus, is not intended to limit the appended claims in any way.

The technologies disclosed herein have been described above with the aid of functional building blocks illustrating the implementation of specified functions and relationships thereof The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the disclosure that others can, by applying knowledge within ordinary skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by an artisan of ordinary skill in light of the teachings and guidance.

The breadth and scope of the present disclosure should not be limited by any of the above-described example embodiments, but should be defined only in accordance with the following claims and their equivalents.

As used in this application and in the claims, a list of items joined by the term “one or more of” can mean any combination of the listed terms. For example, the phrases “one or more of A, B or C” and “one or more of A, B, and C” can mean A; B; C; A and B; A and C; B and C; or A, B and C.

What is claimed is:

1. A monolithic optical splitter assembly, comprising:
at least two inputs;
at least four outputs;
at least one input port for connection to the at least two inputs;
at least one output port for connection to the at least four outputs; and
a splitter array comprising at least two splitters monolithically etched onto a medium, each splitter of the splitter array configured to split a respective optical input signal from a respective input of the at least two inputs and output the respective optical input signal via at least two of the at least four outputs.

2. The monolithic optical splitter assembly of claim 1, wherein the at least two inputs comprise:
a first input configured to input a first optical input signal originating at a first device; and
a second input configured to input a second optical input signal originating at a second device.

3. The monolithic optical splitter assembly of claim 2, wherein the at least four outputs comprise:
a first output configured to output the first optical input signal intended for a third device;
a second output configured to output the first optical input signal intended for the second device;
a third output configured to output the second optical input signal intended for the third device; and
a fourth output configured to output the second optical input signal intended for the first device.

4. The monolithic optical splitter assembly of claim 3, wherein:
the first device comprises a first network device;
the second device comprises a second network device; and
the third device comprises a network analytic device.

5. The monolithic optical splitter assembly of claim 2, wherein the at least four outputs comprise:
a first output configured to output the first optical input signal intended for a third device;
a second output configured to output the first optical input signal intended for the second device;
a third output configured to output the second optical input signal intended for the first device; and
a fourth output configured to output the second optical input signal intended for a fourth device.

6. The monolithic optical splitter assembly of claim 5, wherein:
the first device comprises a first network device;
the second device comprises a second network device;
the third device comprises a first network analytic device; and
the fourth device comprises a second network analytic device.

7. The monolithic optical splitter assembly of claim 1, wherein the at least two inputs comprise:
two or more first inputs each configured to input a respective first optical input signal from a respective individual input fiber of a first ribbonized fiber input cable; and
two or more second inputs each configured to input a respective second optical input signal from a respective individual input fiber of a second ribbonized fiber input cable.

8. The monolithic optical splitter assembly of claim 7, wherein the at least one input port includes a single input port, and wherein the first ribbonized fiber input cable and the second ribbonized fiber input share the single input port.

9. The optical splitter assembly of claim 7, wherein the at least four outputs comprise:
two or more first outputs each configured to output a respective first optical input signal to a respective individual output fiber of a first ribbonized fiber output cable;
two or more second outputs each configured to output a respective second optical input signal to a respective individual output fiber of a second ribbonized fiber output cable;
two or more third outputs each configured to output the respective first optical input signal to a respective individual output fiber of a third ribbonized fiber output cable; and
two or more fourth outputs each configured to output the respective second optical input signal to a respective individual output fiber of a fourth ribbonized fiber output cable.

10. The monolithic optical splitter assembly of claim 9, wherein the at least one output port includes a single output port, and wherein the first, second, third, and fourth ribbonized fiber output cables share the single output port.

11. The monolithic optical splitter assembly of claim 9, wherein the at least one output port includes a first output port and a second output port, and wherein a first two ribbonized fiber output cables of the first, second, third, and fourth ribbonized fiber output cables share the first output port, and the remaining two ribbonized fiber output cables of the first, second, third, and fourth ribbonized fiber output cables share the second output port.

12. The monolithic optical splitter assembly of claim 1, wherein the at least two inputs comprise:
at least one first input each configured to input a respective first optical input signal from a respective individual input fiber of a first ribbonized bidirectional fiber cable; and
at least one second input each configured to input a respective second optical input signal from a respective individual input fiber of a second ribbonized bidirectional fiber cable.

13. The monolithic optical splitter assembly of claim 12, wherein the at least four outputs comprise:
one or more first outputs each configured to output a respective first optical input signal to a respective individual output fiber of the second ribbonized bidirectional fiber cable;
one or more second outputs each configured to output the respective first optical input signal to a respective first individual output fiber of a ribbonized fiber output cable;
one or more third outputs each configured to output a respective second optical input signal to a respective individual output fiber of the first ribbonized bidirectional fiber cable; and
one or more fourth outputs each configured to output the respective second optical input signal to a respective second individual output fiber of the ribbonized fiber output cable.

14. The monolithic optical splitter assembly of claim 13,
wherein the at least one input port includes:
a first port; and
a second port;
wherein the at least one output port includes:
the first port;
the second port; and
a third port; and
wherein the first port is configured to connect to the first ribbonized bidirectional fiber;
wherein the second port is configured to connect to the second ribbonized bidirectional fiber cable; and
wherein the third port is configured to connect to the ribbonized fiber output cable.

15. The monolithic optical splitter assembly of claim 1, wherein the medium is one of a group consisting of: a polymer, silica, or silica on silicon.

16. The monolithic optical splitter assembly of claim 1, wherein the at least one splitter includes at least one splitter that has a 50/50 splitter ratio.

17. The monolithic optical splitter assembly of claim 1, wherein the at least one splitter includes at least one splitter that has a splitter ratio other than a 50/50 splitter ratio.

18. The monolithic optical splitter assembly of claim 1, wherein the splitter array is etched with every other splitter alternating in placement by approximately 180 degrees.

19. The monolithic optical splitter assembly of claim 1, further comprising a housing configured to surround the splitter array and allow access to the at least one input port and the at least one output port.

20. A method of routing an optical signal, comprising:
receiving one or more optical input signals at one or more respective inputs, the one or more optical input signals originating at a first device; and
for each of the one or more optical input signals:
splitting the optical input signal into two or more split input signals along a respective pathway etched onto a medium;
outputting a first split input signal of the two or more split input signals at a first output, the first split input signal intended for a second device; and
outputting a second split input signal of the two or more split input signals at a second output, the second split input signal intended for a third device.

21. The method of claim 20, wherein:
the first device comprises a first network device;
the second device comprises a second network device; and
the third device comprises a network analytic device.

22. The method of claim 20, further comprising:
receiving one or more second optical input signals at one or more respective second inputs, the one or more second optical input signals originating at a second device; and
for each of the one or more second optical input signals:
splitting the second optical input signal into two or more split second input signals along a respective second pathway etched onto the medium;
outputting a first split second input signal of the two or more split second input signals at a third output, the first split second input signal intended for the first device; and
outputting a second split second input signal of the two or more split second input signals at a fourth output, the second split second input signal intended for a fourth device.

23. The method of claim 22, wherein:
the first device comprises a first network device;
the second device comprises a second network device;
the third device comprises a first network analytic device; and
the fourth device comprises a second network analytic device.

24. The method of claim 22, wherein the first and second optical input signals are received at a common input port.

25. The method of claim 22, wherein at least two of the first and second split input signals and the first and second split second input signals are output at a common output port.

26. The method of claim 20, further comprising:
receiving one or more second optical input signals at one or more respective second inputs, the one or more second optical input signals originating at a second device; and
for each of the one or more second optical input signals:
splitting the second optical input signal into two or more split second input signals along a respective second pathway etched onto the medium;
outputting a first split second input signal of the two or more split second input signals at a third output, the first split second input signal intended for the first device; and
outputting a second split second input signal of the two or more split second input signals at a fourth output, the second split second input signal intended for the third device.

27. The method of claim 26, wherein:
the optical input signal is received at a first port;
the second input signal is received at a second port;
the first split input signal is output at the second port;
the second split input signal is output at a third port;
the first split second input signal is output at the first port; and
the second split second input signal is output at the third port.

28. The method of claim 20, wherein the optical input signal is split according to a 50/50 splitter ratio.

29. The method of claim 20, wherein the optical input signal is split according to a splitter ratio other than a 50/50 splitter ratio.
